(19) United States
(12) Patent Application Publication
(10) Pub. No.: US 2015/0321513 A1
(43) Pub. Date: Nov. 12, 2015

(54) Torque Rod Bracket for Mounting a Torque Rod on a Housing of a Tag Axle

(71) Applicant: Daimler AG, Stuttgart (DE)

(72) Inventors: Jeremy CZANSTKE, Milford, MI (US); Juergen ROTH, Bloomfield, MI (US); Kennith STAMPER, Clinton Township, MI (US)

(21) Appl. No.: 14/706,091

(22) Filed: May 7, 2015

(30) Foreign Application Priority Data
May 8, 2014 (GB) 1408156.6

(51) Int. Cl. B60B 35/00; B60B 35/02; F16B 7/04

(52) U.S. Cl. CPC B60B 35/006; F16B 7/0433; B60B 35/02; B60B 2900/313

(57) ABSTRACT

A torque rod bracket for mounting a torque rod on a housing of a tag axle includes at least two bracket parts arranged at a distance from each other, each bracket part having at least two connecting arms being arranged at a distance from each other. The torque rod bracket also includes at least one connecting part by means of which the bracket parts are interconnected. At least a portion of each connecting arm has the form of an upside down T configured to be welded to the housing.

### CROSS-REFERENCE TO RELATED APPLICATIONS

The present application claims priority under 35 U.S.C. §119 to British application GB 1408156.6, filed May 8, 2014, the entire disclosure of which is herein expressly incorporated by reference.

### BACKGROUND AND SUMMARY OF THE INVENTION

Exemplary embodiments of the invention relate to a torque rod bracket for mounting a torque rod on a housing of a tag axle.

Tag axles of vehicles, in particular commercial vehicles, are well-known from the general prior art. Such a tag axle is also referred to as a “trailing axle”. The tag axle comprises a housing which is also referred to as a “tag axle housing” and a torque rod bracket. The torque rod bracket is mounted on the housing. For example, the torque rod bracket is welded to the housing.

The torque rod bracket is configured to be connected to a torque rod. This means the torque rod can be mounted on the torque rod bracket so that the torque rod is mounted on the housing via the torque rod bracket. The torque rod is mounted on the torque rod bracket on one side and a frame of the commercial vehicle on the other side. Thereby, the tag axle is supported on the frame by the torque rod.

U.S. Pat. No. 5,112,078 shows a vehicle suspension system for mounting ground-engaging wheels to a vehicle frame, the suspension system comprising at least two substantially rigid arms secured to opposite sides of the frame through substantially aligned pivot mounts. The suspension system further comprises at least one wheel-carrying axle between said arms and a bracket assembly securing said axle to each of said arms.

The bracket assembly comprises a wrapper plate having an elongated surface complementary to the axle. The wrapper plate has longitudinal side edges and end edges. The suspension system further comprises welds between the side edges of the wrapper plate and the axle to secure the wrapper plate to the axle. The wrapper plate has a notch at one end edge forming at least one finger at one corner of said wrapper plate. One of said welds extends along an outer edge of said finger.

It has been shown that stress concentrations can incur on respective corners of welded joints by means of which the conventional torque rod bracket is attached to the housing of the tag axle. This stress concentration could cause pre-mature failure.

Accordingly, exemplary embodiments of the present invention are directed to a torque rod bracket that can be mounted on a housing of a tag axle particularly advantageously.

Exemplary embodiments of the invention relate to a torque rod bracket for mounting a torque rod on a housing of a tag axle of a vehicle, in particular a commercial vehicle. The torque rod bracket comprises at least two bracket parts arranged at a distance from each other. Each bracket part has at least two connecting arms being arranged at a distance from each other. The torque rod bracket further comprises at least one connecting part by means of which the bracket parts are interconnected. At least a portion of each connecting arm has the form of an upside down T configured to be welded to the housing. In other words, at least a portion of the respective connecting arm is T-shaped, wherein the T-shape is arranged upside down with respect to the vertical direction of the vehicle. The T-shape has a first portion and a second portion extending at least substantially perpendicularly or diagonally to the first portion of the T-shape. Preferably, the respective connecting arm is welded to the housing via the first portion.

Thereby, the torque rod bracket can be attached to the housing by welded joints, wherein stress concentration at the welded joints can be kept particularly low. The idea behind the torque rod bracket according to the present invention is that typical torque rod brackets often fail at the welded joints due to a lateral movement of the lateral torque rod connecting the tag axle to a frame of the vehicle during vehicle operation. It has been found that typical torque rod brackets often are too rigid and cause stress directly at the corner of the welded joints, which creates stress concentration and ultimately a failed connection, for example, in the form of cracks in the welded joints.

The upside down T-shapes of the connecting arms help allow the torque rod bracket to flex and bend slightly to prevent the welded joints from getting excessive stress. The design of the torque rod bracket according to the present invention is based on optimization analysis that uses given stress and design and manufacturing constraints to develop a specific profile.

Preferably, each bracket part and/or the connecting part has at least one weight reduction through opening. Thus, the bracket parts and/or the connecting part are developed as special weight reduction pockets or profiles which can be made from, for example, sheet metal by laser cutting. With this optimization, excessive material that is not needed for structural stability can be removed or avoided.

In a particularly advantageous embodiment of the invention, the bracket parts and the connecting part are formed in one piece. Thereby, the number of parts of the torque rod bracket according to the present invention can be kept particularly low.

Further advantages, features, and details of the present invention derive from the following description of a preferred embodiment as well as from the drawings. The features and feature combinations previously mentioned in the description as well as the features and feature combinations mentioned in the following description of the figures and/or shown in the figures alone can be employed not only in the respective indicated combination but also in any combination or taken alone without leaving the scope of the invention.

FIGS. 7a-h illustrate the background of the invention.

### BRIEF DESCRIPTION OF THE DRAWING FIGURES

The drawings show in:

FIG. 1 a schematic perspective view of a tag axle for a commercial vehicle, the tag axle having a housing and a torque rod bracket for mounting a torque rod on the housing;

FIG. 2 a schematic perspective view of the torque rod bracket comprising two bracket parts, a connecting part, and a mounting block;

FIG. 3 a further schematic perspective view of the torque rod bracket ;

FIG. 4 a schematic perspective view of the torque rod bracket without the mounting block;

FIG. 5 a further schematic perspective view of the torque rod bracket without the mounting block;

FIG. 6 a schematic perspective view of the mounting block; and

FIG. 7a-h respective schematic perspective views of torque rod brackets illustrating the background of the invention.

In the figures the same elements or elements having the same functions are designated with the same reference signs.

### DETAILED DESCRIPTION

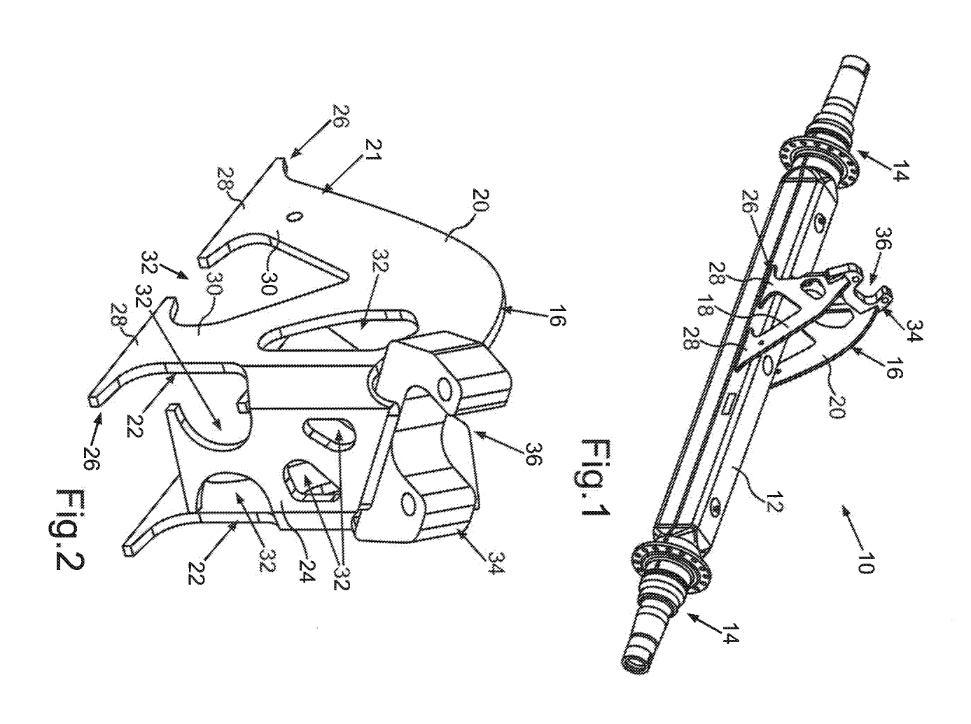

FIG. 1 shows a tag axle 10 for a commercial vehicle. The tag axle 10 is also referred to as a “trailing axle” and comprises a housing 12 and wheel hubs 14. Moreover, the tag axle 10 comprises a torque rod bracket 16 welded to the housing 12. The torque rod bracket 16 serves to mount a torque rod on the housing 12. In other words, with respect to an assembled state of the commercial vehicle, the torque rod is mounted on a frame of the commercial vehicle on one side and the torque rod bracket 16 on the other side so that the tag axle 10 is supported on the frame by the lateral torque rod.

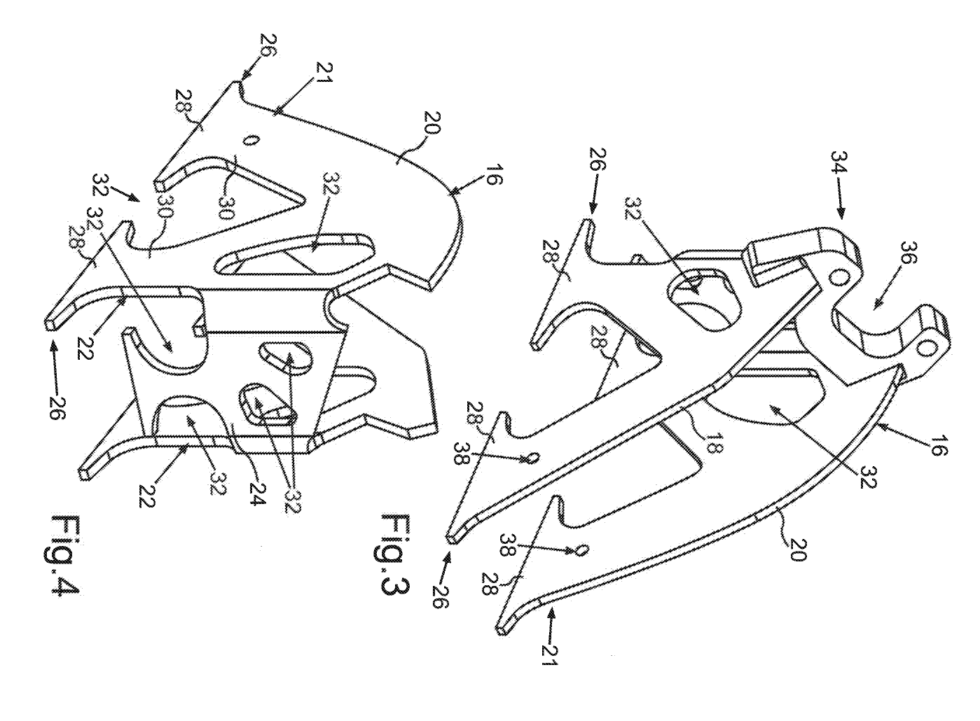

As can be seen in FIGS. 1-5, the torque rod bracket 16 comprises two bracket parts 18, 20 arranged at a distance from each other in the longitudinal direction of the vehicle. Each bracket part 18, 20 has two connecting arms 21, 22 arranged at a distance from each other in the transverse direction of the vehicle.

Moreover, the torque rod bracket 16 has a connecting part 24 by means of which the bracket parts 18, 20 are interconnected. The bracket parts 18, 20 and the connecting part 24 are formed in one piece. Preferably, the bracket parts 18, 20 and the connecting part 24 are made from sheet metal by laser cutting.

An end portion 26 of the respective connecting arm 21, 22 has the form of an upside down T welded to the housing 12. In other words, the respective connecting arm 21, 22 has an upside down T foot formed by the T-shaped end portion 26. The T-shape has a first portion 28 and a second portion 30 extending perpendicularly or diagonally to the first portion 28. The respective first portion 28 is attached to the housing 12 by welded joints. Moreover, the bracket parts 18, 20 and the connecting part 24 have respective weight reduction through openings 32 so that the weight of the torque rod bracket 16 can be kept particularly low.

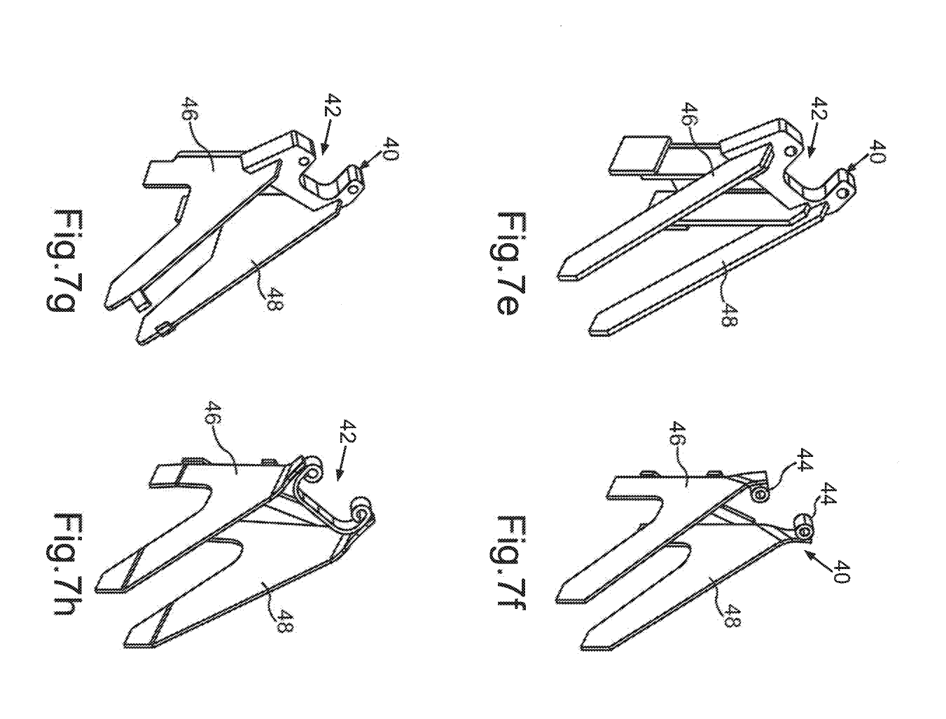

The mounting bracket 16 further comprises a mounting block 34 shown in FIG. 6. For example, the mounting block 34 is made of a metallic material. The mounting block 34 is attached to the respective bracket parts 18, 20. For example, the mounting block 34 is welded to the bracket parts 18, 20. Thus, the bracket parts 18, 20 are connected to one another by the mounting block 34.

The mounting block 34 has a receptacle 36, wherein at least a portion of the torque rod can be arranged in the receptacle 36. The upper mounting block 34 has an improved design based on optimization analysis. The upper mounting block 34 has a specific contour for excessive material removal while maintaining its structural durability. The lateral torque rod bracket 16 has a design by means of which the torque rod bracket 16 can be welded to the housing 12 particularly easily. Moreover, the torque rod bracket 16 has a particularly low number of parts.

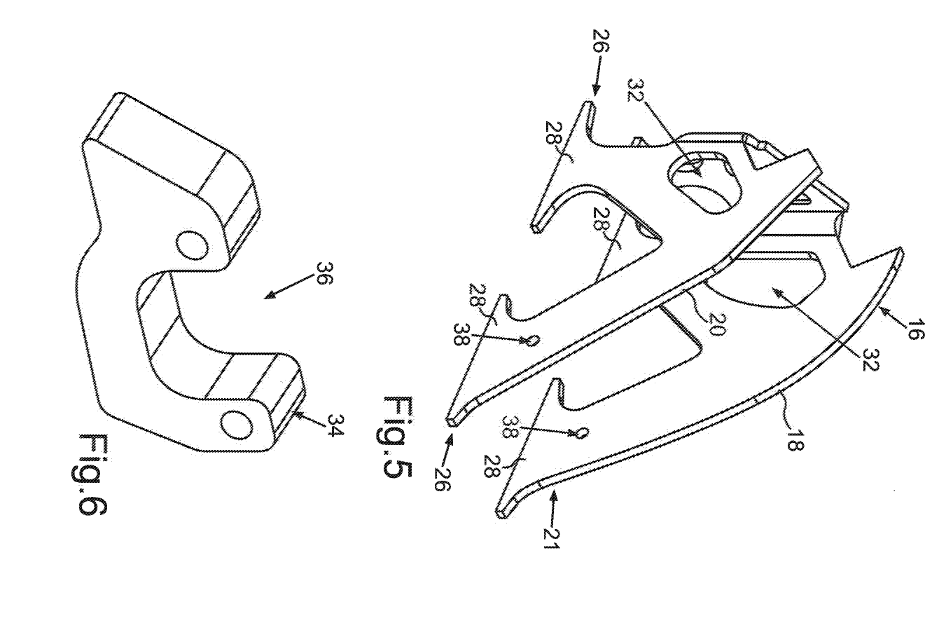

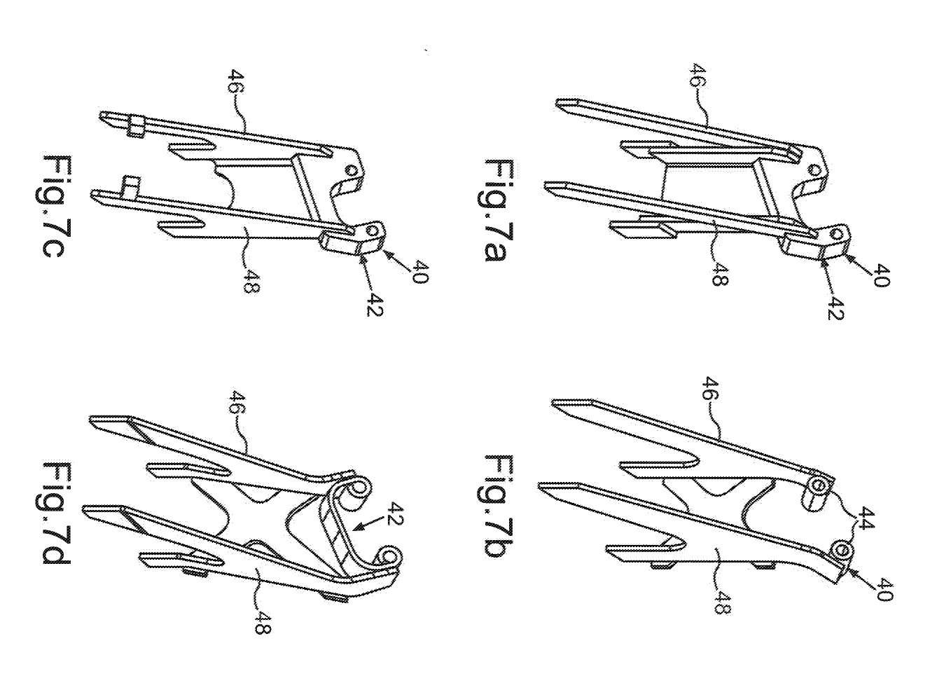

As can be seen in FIGS. 3 and 5, the torque rod brackets 16 has two in-line holes 38 in the form of through openings. The in-line holes 38 are formed in the respective bracket parts 18, 20. The in-line holes 38 are used to locate the torque rod bracket 16 onto the housing 12. For example, the in-line holes 38 are used for temporary assembly of a rod to help in positioning. Once welded, the rod will be removed out of the in-line holes 38.

The torque rod bracket 16 allows realizing robust welded joints to the housing 12. Moreover, the number of parts and the weight of the torque rod bracket 16 can be kept particularly low. Furthermore, the torque rod bracket 16 can be attached to the housing 12 particularly easily. FIGS. 7a-h show different embodiments of a torque rod bracket 40. The torque rod bracket 40 does not have the upside down T-shaped end portions 26. Moreover, the torque rod bracket 40 has a higher number of parts than torque rod bracket 16. The torque rod bracket 40 according to FIGS. 7a, 7c, 7d, 7e, 7g and 7h has a mounting block 42. However, the torque rod bracket 40 according to FIGS. 7b and 7f does not have a mounting block but two separate mounting elements 44 attached to respective bracket parts 46, 48 of the torque rod bracket 40.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 tag axle

12 housing

14 wheel hub

16 torque rod bracket

18 bracket part

20 bracket part

21 connecting arm

22 connecting arm

24 connecting part

26 end portion

28 first portion

30 first portion

32 weight reduction through opening

34 mounting block

36 receptacle

38 hole

40 mounting bracket

42 mounting block

44 mounting element

46 bracket part

48 bracket part

What is claimed is:

1. A torque rod bracket for mounting a torque rod on a housing of a tag axle, the torque rod bracket comprising:
at least two bracket parts arranged at a distance from each other, each of the at least two bracket parts has at least two connecting arms arranged at a distance from each other; and
at least one connecting part that interconnects the at least two bracket parts, wherein at least a portion of each connecting arm of the at least two bracket parts has a form of an upside down T that is configured for welding to the housing of the tag axle.

2. The torque rod bracket of claim 1, wherein the at least two bracket parts and the connecting part are formed as a single piece.

3. The torque rod bracket of claim 1, wherein the torque rod bracket further comprises:
a mounting block attached to the at least two bracket parts.

4. The torque rod bracket of claim 3, wherein the mounting block has a receptacle configured to receive at least a portion of the torque rod.

5. The torque rod bracket of claim 1, wherein each of the at least two bracket parts or the at least one connecting part has at least one weight reduction through opening.

6. The torque rod bracket of claim 1, wherein the at least two bracket parts are made from sheet metal by laser cutting.

7. A tag axle for a vehicle, the tag axle comprising:
a housing; and
at least one torque rod bracket, comprising
at least two bracket parts arranged at a distance from each other, each of the at least two bracket parts has at least two connecting arms arranged at a distance from each other; and
at least one connecting part that interconnects the at least two bracket parts, wherein at least a portion of each connecting arm of the at least two bracket parts has a form of an upside down T that welded to the housing of the tag axle.

8. The tag axle of claim 7, wherein the at least two bracket parts and the connecting part are formed as a single piece.

9. The tag axle of claim 7, wherein the torque rod bracket further comprises:
a mounting block attached to the at least two bracket parts.

10. The tag axle of claim 9, wherein the mounting block has a receptacle configured to receive at least a portion of the torque rod.

11. The tag axle of claim 7, wherein each of the at least two bracket parts or the at least one connecting part has at least one weight reduction through opening.

12. The tag axle of claim 7, wherein the at least two bracket parts are made from sheet metal by laser cutting.
